(19) United States
(12) Patent Application Publication
(10) Pub. No.: US 2007/0101666 A1
(43) Pub. Date: May 10, 2007

(54) Corrugated plastic storm shutter system

(76) Inventor: James A. Munch, Melbourne, FL (US)

Correspondence Address: LITMAN LAW OFFICES, LTD., P.O. BOX 15035, CRYSTAL CITY STATION, ARLINGTON, VA, 22215, US

(21) Appl. No.: 11/254,734

(22) Filed: Oct. 21, 2005

(51) Int. Cl. E06B 3/26

(52) U.S. Cl. 52/202

(57) ABSTRACT

The corrugated storm shutter system protects glass-covered openings from damage during windstorms. The system components include plastic panels for covering the building openings, and fastening hardware for securing the panels to the buildings. The panels may be removed from the windows during periods when windstorms are not anticipated. The panels are made of corrugated plastic material with the corrugations consisting of parallel flutes connecting the upper and lower surfaces of the panels. A single panel may be used to cover an opening window, or alternatively an opening may be horizontally spanned by a plurality of panels connected by bridging members. Mounting hardware is provided for securing the panels to a building surface over openings to be protected. The mounting hardware consists of a fastener having a lower portion adapted for penetrating and holding to a masonry surface and an upper threaded portion adapted for engaging a mating nut.

### BACKGROUND OF THE INVENTION

1. Field of the Invention

The present invention relates to systems for protecting buildings from storm damage, and more particularly to a corrugated storm shutter system that provides a barrier for protecting building openings from damage caused by high-speed winds.

2. Description of the Related Art

Severe windstorms such as tropical storms and hurricanes can cause extensive and expensive damages to buildings. Glass covered openings are particularly susceptible to wind caused damage. Glass may be used to cover openings of various sizes. Glass covered openings include windows, sliding doors, and skylights. Replacing broken glass after a storm may be an expensive labor-intensive operation. Additionally, when glass covered openings are compromised during a storm, the interior of the building may be exposed to damage from the storm due to rain, wind, and other elements predictably accompanying the storm.

Winds may causes damage to glass and other opening covering materials directly due to high force generated against the window or indirectly. High-speed winds may cause indirect damage fragile opening materials such as glass or plastic materials by imparting velocity to debris and delivering the debris as projectiles against the windows, doors, or other openings.

One scheme for protecting openings is to cover them with sheets of a rigid material such as plywood. In a typical scheme, plywood sheets are secured over the windows of a building during a time when a windstorm is anticipated. The installation of the plywood sheets is time consuming because sheets of the thickness required to provide adequate protection are relatively heavy. The plywood covers are cut from larger sheets, which is also a time consuming laborious task. After removal, the plywood may be stored for use during future storms, but wood is subject to degradation after repeated exposure to wet weather, and is also susceptible to attack by insects, such as termites, ants and roaches, and to rotting attacks from fungi and other biological agents. When the plywood degrades to the point where it cannot provide adequate storm protection, the plywood must be replaced. Thus the expense of procuring and shaping the plywood covers must be born repeatedly.

Because plywood is opaque, covering the windows with plywood prevents external light from entering the building. Quite often severe windstorms cause damage to the electrical power distribution infrastructure causing a loss of electrical power to the building and the consequent loss of building lighting. It would be advantageous for a window protection scheme to employ transparent or translucent materials to natural lighting to enter the building when electrical lighting is unavailable.

The recommended performance for storm resistant covers is described in the ASTM E 1996, the Standard Specification for Performance of Exterior Windows, Glazed Curtain Walls, Doors and Storm Shutters Impacted by Wind-borne Debris in Hurricanes written by the American Society of Testing and Materials. Storm covers made of plywood, while allowed in some jurisdictions, have been demonstrated to be unable to meet the impact resistance requirements of ASTM E 1996. A shuttering system made of a lightweight material, that would not degrade with exposure to weathering elements, such as sunlight and water exposure, and which could resist attack biological attacks while providing the required strength, is desirable. A shuttering system requiring only small amounts of labor to install and to remove, and which could be reused over a number of storm seasons, would be economical compared to plywood based systems.

Japanese Patent No. 3-119,248, published May 21, 1991, shows in FIG. 4 a system incorporating a corrugated board for protecting against storm damage caused by water. Japanese Patent No. 2001-262,945, published Sep. 26, 2001, shows in FIG. 1 a translucent panel mounted on the exterior of a window for the purpose of admitting light to the interior of a building while preserving privacy within a room of the building. These references are indicative of the state of the art, but differ in structure and function from and do not solve the same problems as the instant invention.

None of the above inventions and patents, taken either singly or in combination, is seen to describe the instant invention as claimed. Thus, a corrugated storm shutter system solving the aforementioned problems is desired.

### SUMMARY OF THE INVENTION

The corrugated plastic storm shutter system protects glass covered building openings such as windows, sliding doors, and skylights, from damage during severe windstorms. The system components include plastic panels for covering the building openings and fastening hardware for securing the panels to the buildings. The panels may be removed from the windows during periods when windstorms are not anticipated. The panels are made of corrugated plastic material with the corrugations consisting of parallel flutes connecting the upper and lower surfaces of the panels. A single panel may be used to cover an opening window, or alternatively an opening may be horizontally spanned by a plurality of panels connected by bridging members.

Mounting hardware is provided for securing the panels to a building surface over openings to be protected. The mounting hardware is a fastener having a lower portion adapted for penetrating and holding to a masonry surface and an upper threaded portion adapted for engaging a mating nut. The fasteners are installed by threading the lower fastener portion into the building surface around the perimeter of the opening. The panels are provided with holes that slidably engage the upper portions of the fasteners. The panels may be secured to the building surface by threading fastening nuts onto the upper portions of the threaded fasteners and tightening the nuts against the exterior surface of the panels.

When multiple panels are used to span the width of an opening, a bridging member is provided. The bridging members consist of a base portion of sufficient width to attach panels to opposite sides of the bridge and a riser section which extends perpendicular from the exterior surface of the base and which provides lateral support to the attached panels. When installed, the bridging member spans the opening vertically.

In one embodiment the corrugated plastic panels are made of a translucent polymeric material such as a polypropylene copolymer. The thickness of the corrugated panel may be approximately 16 millimeters thick with the flutes spaced to provide a linear flute density of approximately 36 flutes per linear foot.

These and other features of the present invention will become readily apparent upon further review of the following specification and drawings.

### BRIEF DESCRIPTION OF THE DRAWINGS

FIG. 1 is a perspective view of a corrugated plastic storm shutter system according to the present invention installed over a window.

FIG. 2 is a perspective view of dual panel storm shutter system according to the present invention installed over a window.

FIG. 3 is a perspective view of a storm shutter panel according to the present invention.

FIG. 4A is a perspective view of panel mounting hardware according to the present invention.

FIG. 4B is a side view of panel mounting hardware according to the present invention as installed in a building wall.

FIG. 4B is a side view of panel mounting hardware according to the present invention with a protective cap.

FIG. 5 is a front perspective view of bridging element for a multi-panel storm shutter system according to the present invention.

Similar reference characters denote corresponding features consistently throughout the attached drawings.

### DETAILED DESCRIPTION OF THE PREFERRED EMBODIMENTS

Referring now to the drawings, an installation of the components of a system for protecting building openings from severe whether may be appreciated.

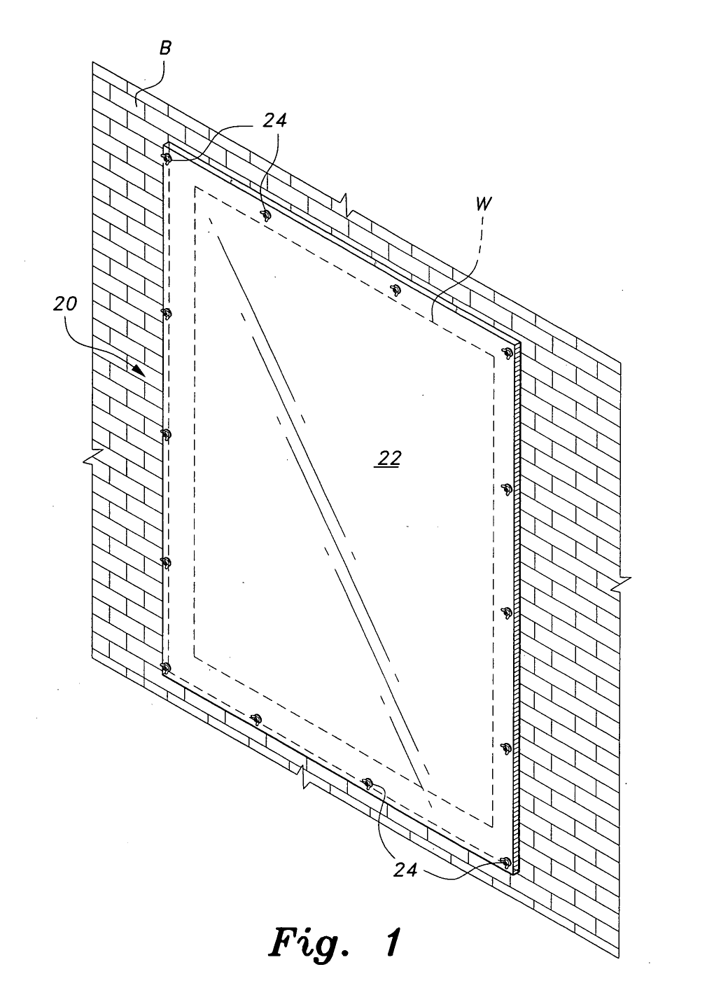

Referring first to FIG. 1 a window opening W is protected using a storm shutter system 20 according to the invention. The components of the storm shutter system include a panel 22 that provides a storm resistant barrier to the window, and mounting hardware 24 for securing the panels to the walls of a building B. The building walls may be masonry, concrete, or other building material. The mounting hardware may be operated to release the panel 22 allowing the panel 22 to be removed from the window W when the threat of high winds from a storm such as a hurricane or tropical storm is not present.

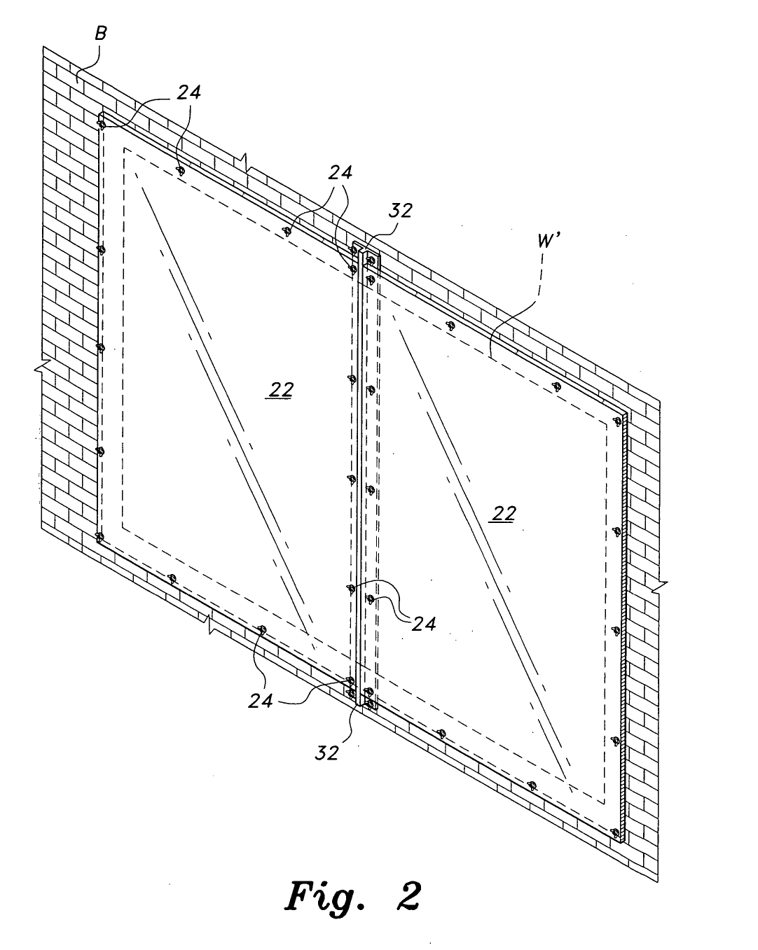

FIG. 2 shows a second storm shutter system 120. The second storm shutter system 120 includes a plurality of panels for spanning an opening wider than that of a single panel such as a wide window W′ or a sliding glass door. The wide window storm shutter system 120 further includes a bridging member 30 which provides an attachment for spanning the window W′, mounting hardware 24 for securing the panels to the building, and bridge mounting hardware 32 for securing the bridge members 30 to the wall of a building B.

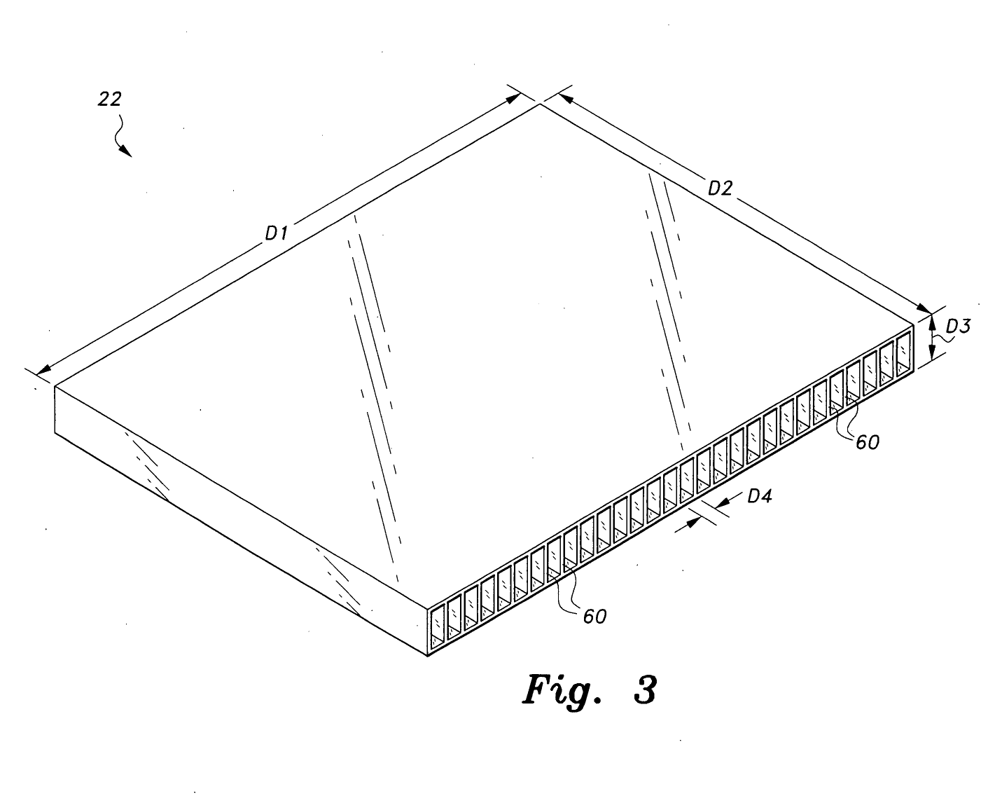

By referring to FIG. 3, details of the construction of the protective panels 22 may be appreciated. The protective panel 22 is made of a lightweight material with sufficient strength to absorb the impact of storm wind driven debris. The required impact performance for the panels is described in ASTM E 1996, the Standard Specification for Performance of Exterior Windows, Glazed Curtain Walls, Doors and Storm Shutters Impacted by Wind-borne Debris in Hurricanes written by the American Society of Testing and Materials, herein incorporated by reference.

Preferably the material of the panel 22 is a high-density polyethylene or polypropylene material. The material of the panel is preferably translucent allowing partial transmission of exterior light through the panel and into the building. Polymeric materials used to construct the panels may include additives to provide resistance to flame, water and exposure to ultra violet light.

The panels are provided in a variety of lengths (dimension D1) and widths (dimension D2) to allow accommodating a variety of openings. As may be appreciated from FIGS. 1 and 2, the length height D1 of the panels must be sufficient to span the height of the window W while the cumulative width D2 of the panels and bridge members must span the width of the opening. The length of width of the panels also includes an effective overlap allowing the panels to rest against the surface of building to provide sufficient support. In addition, the effective overlap provided by the length and the width of the panels compared to the corresponding dimensions of the opening provides sufficient overlapping area to accommodate the hardware 24 for mounting the panels to the building. The panels may be provided in sizes for covering a single window, or in sheets of that can be cut into panels for two or more windows. By providing the panels in sizes consistent with common window sizes cutting operations may be eliminated. Providing the material in sizes that are even multiples of standard window sizes minimizes the production of unusable waste when cutting the panels. Preferably the panels are provided in sizes including 48 inches by 96 inches, 96 inches by 80 inches, 80 inches by 108 inches, and 96 inches by 108 inches.

The panels 22 are of a corrugated construction with the upper surface and the lower surfaces of a panel being separated by flutes 60. The flutes extend across the width of the 22. When the panel 22 is installed over a window or other opening, the flutes 60 preferably extend horizontally across the opening.

The flutes 60 are spaced sufficiently closely so that the linear density of the flutes provides adequate strength to the panel 22 to resist an impact of wind driven debris without allowing the panel 22 to deflect into the window with sufficient force to break a glass door or window protected by the panel 22. In a preferred embodiment, the overall thickness D3 of the panel 22 is approximately 16 millimeters, with the flute spacing D4 being approximately ⅓ of an inch, producing a flute density of 36 flutes per linear foot.

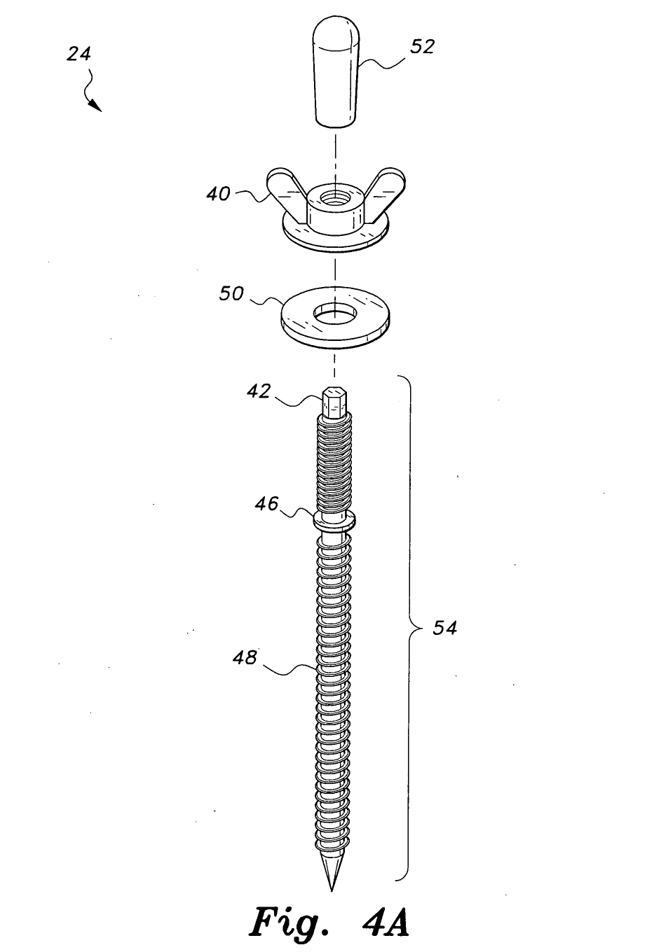

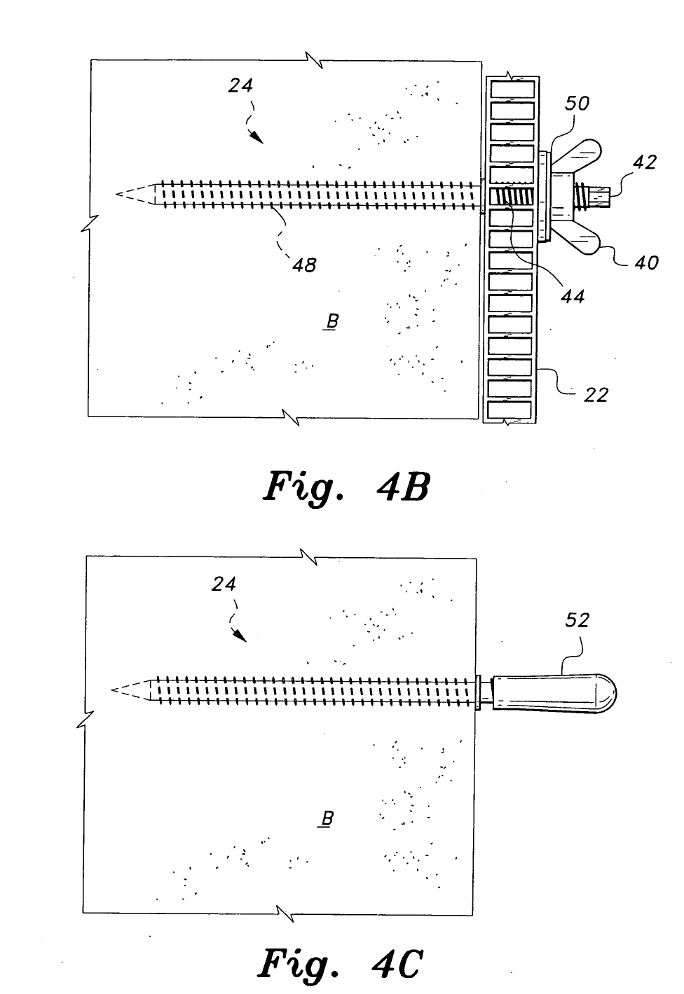

Features of mounting hardware in accordance with an embodiment of the invention may be appreciated by referring to FIGS. 4A, 4B, and 4C. Referring first to FIG. 4A, the mounting hardware 24 for mounting the panels to a masonry or concrete wall comprises a threaded fastener 54 and a wing nut 40. The threaded fastener 54 comprises a lower thread portion 48, a stop ring 46, an upper threaded portion 44, and an upper cap portion 42. The threads of the lower portion 48 are optimized for retention into a masonry or concrete material or other material of which a building wall, or window or doorframe may be made. The stop ring is a disk located at the top of the threaded portion 48 and concentric with the fastener axis. As can be appreciated by referring to FIG. 4B, when installing the fastener, the stop ring 46 limits the penetration of the fastener 54 into the supporting surface so that the upper portion of the fastener, which is used to mount the panel 22, remains accessible exterior to the mounting surface.

The upper threaded portion of the fastener 48 has threads that mate with the threads of the wing nut 40. The wing nut 40 is used to secure the panel 22 to the building support surface. As may be appreciated from FIGS. 4A and 4B, when the panel is installed over a window, the upper threaded portion 44 of the fastener passes through a hole drilled, or punched in the panel 22. A washer 50 is threaded over the end of the fastener and rests on the exterior surface of the panel. The washer 50 provides a hardened surface for the wing nut 40 to press against when the wing nut 40 is tightened to hold the panel to the mounting surface such as a building wall B.

Referring again to FIG. 4B, it can be appreciated that the length of the upper threaded portion 44 is sufficient long to accommodate the thickness of the panel 22, and the washer 50, and to engage the threads of the wing nut 40.

As best seen in FIG. 4A, the cap portion 42 of the fastener 54 is adapted for engagement by an installation tool. In the illustrated embodiment, the cap portion 42 has a hexagonal cross section, providing faces for engaging a tool for threading the lower threaded portion 48 of the fastener into the mounting surface B.

A thread protector 52 may be provided for protecting the threads of the fastener 54 when the storm protector panels 22 are not being used. The storm panels 22 may be removed from the windows when severe winds are not anticipated. As appreciated in FIG. 4C, when the panels are removed, the upper threaded portion 44 of the fasteners are exposed. The exposed threads may be subject to damage, which interferes with the wing nut's engagement of the fasteners compromising the ability of the storm shutter system to protect openings against winds and wind propelled debris.

The thread protector 52 is adapted to slide over the upper portion of the fastener covering the exposed threads of the fastener. The thread protector 52 is made of a resilient material such as rubber, neoprene, or soft plastic allowing the thread protector to absorb the force of an impact with the fastener 54 without damaging the portion of the fastener exterior to the building B.

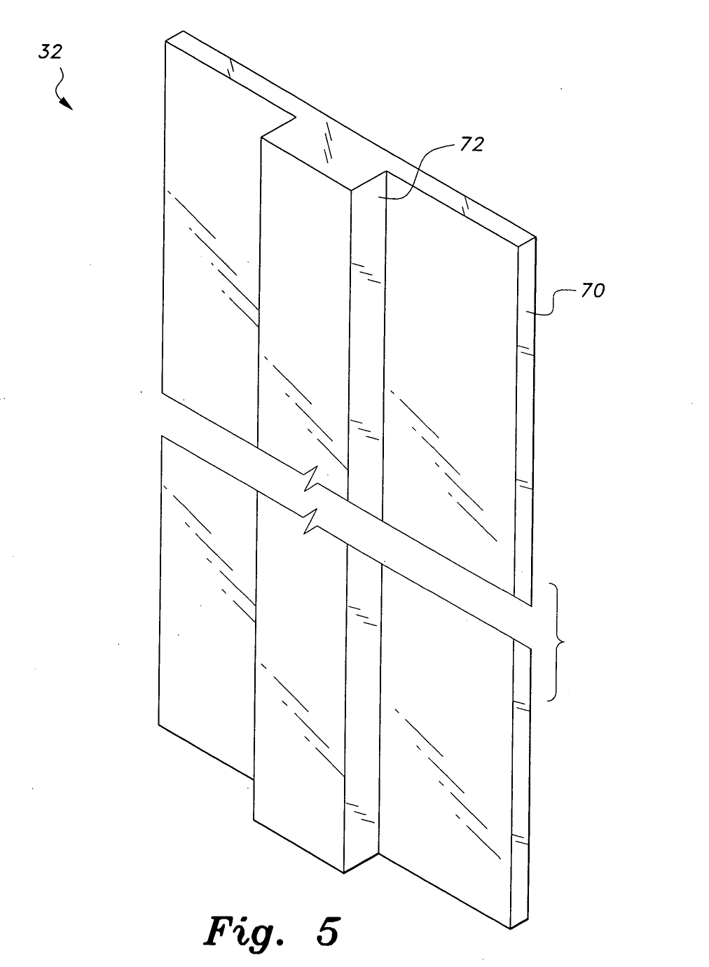

Referring now to FIGS. 2 and 5, details of the bridging member 30 may be understood. As described above, the bridging member 30 enables spanning the width of a window W′ whose width is greater than that of a single panel. The bridging member 30 comprises a base portion 70 and a riser portion 72. The base portion provides a supporting surface for attaching the panels 22 of the storm shutter system 20. The riser 72 extends perpendicular to the base on the exterior portion of the bridging member. The riser provides lateral support for the panels when attached to the bridge 30. When, the bridging member 30 is used to span a window, the bridging member 30 is installed so that the base spans the window vertically at a position within the perimeter of the window. For example when two panels 22 are used as shown in FIG. 2, the bridging member spans the window vertically and is installed at a point near the horizontal center of the window W′. The bridging member 30 is long enough to provide an effective overlap above and below the window W′. The bridging member is secured to the supporting surface of the building B using bridge fastening hardware 32. The bridge fastening hardware may comprise fasteners identical to those used for installing the panels. Each panel is mounted by attaching one side of the panel to a corresponding building surface while attaching the opposite side of the panel to the bridge. The panels may be attached to bridging member using fastening means such as screws passing through corresponding holes in the base of the bridging member and the panels and securing nuts threaded onto the screws. The bridging member may be made of any strong rigid material such as metal or strong plastic materials such as high-density polyethylene or polypropylene.

The installed storm shutter system achieves the required strength for resisting impacts from wind blown debris due to the strength and energy absorbing capability of the panels, and proper mounting. In one embodiment, the effective overlap provided by the panels is approximately four inches around the entire perimeter of a protected opening, with the fasteners being provided at approximately every fourteen inches, the fasteners being located six inches from any panel corner. The mounting hardware is installed at locations around the entire perimeter of the opening. The lower threaded portion of the panel mounting fasteners provides an embedded length of 1⅞ inches. The corrugated panels are made of impact polypropylene having a density of approximately 0.68 pounds per square foot. The thickness of the corrugated panels is approximately sixteen millimeters with a fluting density of approximately thirty-six flutes per linear foot. The installed shutter system having these dimensions has a Zone 4 missile impact resistance as specified in ASTM E 1996, the Standard Specification for Performance of Exterior Windows, Glazed Curtain Walls, Doors and Storm Shutters Impacted by Wind-borne Debris in Hurricanes. The particular dimensions and materials specified are provided for enablement purposes and do not limit the invention to the described dimensions or materials.

It is to be understood that the present invention is not limited to the embodiments described above, but encompasses any and all embodiments within the scope of the following claims.

I claim:

1. A corrugated plastic storm shutter system adapted to cover an opening in a building surface, the system comprising:
a corrugated plastic panel having an upper surface and a lower surface, and a plurality of substantially parallel corrugating flutes disposed between the upper and lower surfaces;
at least one panel mounting fastener for securing the panels to a building surface over the opening, the fasteners including:
a lower threaded portion having threads adapted for penetrating masonry of a building wall;
a stop ring having a disk concentric to the lower thread portion and located at the top of the lower thread portion; and
an upper threaded portion above the stop ring and coaxial to the lower thread portion; and
a threaded nut threadably engaging the upper thread portion of the fastener.

2. The corrugated plastic storm shutter system according to claim 1, further comprising:
at least one bridging member made of a rigid material, the bridging member having a base with a length adapted to span the vertical dimension of the window opening and a rise section substantially perpendicular to the base;
a plurality of corrugated plastic panels, each panel having an upper surface, a lower surface, and a plurality of substantially parallel corrugating flutes disposed between the upper and lower surfaces.

3. The corrugated plastic storm shutter system according to claim 1, wherein the corrugated panel is made of a translucent plastic material.

4. The corrugated plastic storm shutter system according to claim 1, wherein the corrugated panel is made of polypropylene copolymer.

5. The corrugated plastic storm shutter system according to claim 1, wherein the thickness of the corrugated panel is approximately sixteen millimeters.

6. The corrugated plastic storm shutter system according to claim 1, wherein the corrugating flutes are spaced to provide a flute density of approximately 36 flutes per linear foot.

7. The corrugated plastic storm shutter system according to claim 1, wherein the threaded nut is a wing nut.

8. The corrugated plastic storm shutter system according to claim 1, wherein the panel mounting fastener further comprises a turning surface for adapted for threading the fastener lower threaded portion into the surface of the building the turning surface comprising a faceted surface for engaging a turning tool.

9. A corrugated plastic storm shutter for covering an opening in a building wall, the shutter comprising:
a corrugated plastic panel having an upper surface, a lower surface, and a plurality of substantially parallel corrugating flutes disposed between the upper and lower surfaces, the corrugated panel being adapted for overlapping the perimeter of the opening by an effective overlap distance
at least one panel mounting fastener installed in the exterior of the building surface for securing the panels to a building surface over the opening, the fasteners including:
a lower threaded portion having threads adapted for penetrating masonry of a building wall, the lower threaded portion threadably engaging the building wall around the perimeter of the opening;
a stop ring comprising a disk concentric to the lower thread portion and located at the top of the lower thread portion; and
an upper threaded portion above the stop ring and coaxial to the lower thread portion the upper threaded portion slidably engaging holes through the surface of the corrugated plastic panel; and
a threaded nut threadably engaging the upper thread portion of the fastener and tightened to secure the corrugate panel against the surface of the building.

10. The corrugated plastic storm shutter according to claim 9, wherein the corrugated panels are made of a translucent plastic material.

11. The corrugated plastic storm shutter system according to claim 9, wherein the corrugated panel is made of polypropylene copolymer.

12. The corrugated plastic storm shutter system according to claim 11, wherein the thickness of the corrugated panel is approximately 16 millimeters.

13. The corrugated plastic storm shutter system according to claim 9, wherein the effective overlap distance is approximately 4 inches.

14. The corrugated plastic storm shutter system according to claim 9, wherein the corrugating flutes of the corrugated panel extend horizontally across the opening.

15. A corrugated plastic storm shutter for covering an opening in a building wall, the shutter comprising:
a plurality of corrugated plastic panels, each panel comprising an upper surface, a lower surface, and a plurality of substantially parallel corrugating flutes disposed between the upper and lower surfaces, a combined area covered by the plurality of corrugated panels being adapted for overlapping a perimeter of the opening by an effective overlap distance;
at least one bridging member made of a rigid material, the bridging member including a base having a length adapted to span the vertical dimension of the window opening and a rise section substantially perpendicular to the base, the bridging member being adapted for spanning the opening vertically, the bridging member being positioned adjacent to at least one of the corrugated plastic panels;
at least one panel mounting fastener installed in the exterior of the building surface for securing the panels to a building surface over the opening, the fastener comprising:
a lower threaded portion having threads adapted for penetrating masonry of a building wall, the lower threaded portion threadably engaging the building wall around the perimeter of the opening;
a stop ring having a disk concentric to the lower thread portion and located at the top of the lower thread portion; and
an upper threaded portion above the stop ring and coaxial to the lower thread portion the upper threaded portion slidably engaging holes through the surface of one of the corrugated plastic panels; and
a threaded nut threadably engaging the upper thread portion of the fastener and tightened to secure the corrugate panel against the surface of the building.

16. The corrugated plastic storm shutter according to claim 15, wherein the corrugated panels are made of polypropylene copolymer.

17. The corrugated plastic storm shutter according to claim 15, wherein the thickness of the corrugated panels is approximately 16 millimeters.

18. The corrugated plastic storm shutter according to claim 15, wherein the effective overlap distance is approximately 4 inches.
